(19) United States
(12) Patent Application Publication
(10) Pub. No.: US 2011/0321043 A1
(43) Pub. Date: Dec. 29, 2011

(54) System, Method and Program Product for Native Interface Optimization of Read-Only Arrays

(75) Inventors: Michael H. Dawson, Ottawa (CA); Graeme D. Johnson, Ottawa (CA)

(73) Assignee: INTERNATIONAL BUSINESS MACHINES CORPORATION, Armonk, NY (US)

(21) Appl. No.: 13/091,649

(22) Filed: Apr. 21, 2011

(30) Foreign Application Priority Data
Jun. 29, 2010 (CA) 2707249

(51) Int. Cl. G06F 9/455

(52) U.S. Cl. 718/1

(57) ABSTRACT

A computer-implemented process, system and program product for remote array processing receives a requested array in a remote execution container, generates a fingerprint of the requested array, bundles the fingerprint with the requested array and returns a pointer to array elements of the requested array to a caller. The computer-implemented process further receives a call to release the requested array from the caller to form a received release, determines, using the fingerprint, whether the requested array has been modified and responsive to a determination that the array has been modified, sending a call to release the requested array to a virtual machine and responsive to a determination that the array has not been modified, not sending a call to release the requested array to a virtual machine.

### BACKGROUND

1. Field

This disclosure relates generally to remote processing using an interface protocol in a data processing system, and more specifically to optimization of remote array processing using a Java native Interface protocol in data processing systems.

2. Description of the Related Art

Java Virtual Machine (JVM) implementations support the Java Native Interface (JNI) as a mechanism which allows Java code to call methods written in C and C++ (native code) and vice versa. Traditionally, both the code written in Java and the native code is executed in the same process and by the same thread as execution transitions between the two execution environments.

It is possible, however, to construct a JVM enabling the native code to run in one or more remote execution containers. The remote execution containers may be hosted in separate processes on the same or different machines from where the Java code is executed such that the native code is unaware it is executing separately from the JVM. The separation prevents misbehaved native code from destabilizing the JVM and enables running the native code in a different environment, for example, security context, and bit width, than the main JVM environment. In a split JVM, the overhead and latency associated with calls between Java code and native code is much greater than when using a single process, resulting in a need to reduce call-return round-trips where possible.

With reference to FIG. 3, a pictorial representation of a split JVM environment is presented. Environments 300 is an example including both a traditional Java virtual machine 302 and distributed Java virtual machine 304. Traditional Java virtual machine 302 illustrates a single Java process with a single thread running Java natives.

In contrast, distributed Java virtual machine 304 comprises Java process 306 and remote execution container 308. Between Java process 306 and remote execution container 308 of distributed Java virtual machine 304 is a sequence of data transmission in which the natives of the thread processing in remote execution container 308 communicate with Java process 306.

To enable native code to work with arrays, the native code may use a pair of Get<Type>ArrayElements and Release<Type>ArrayElements calls where <Type> is one of Boolean, Byte, Char, Short, Int, Long, Float, or Double. In a split environment, such as distributed Java virtual machine 304, each use of an array incurs two round-trips. One round-trip to obtain the original array contents and then a second round-trip to release/commit changes that were made to the array.

With reference to FIG. 4, a textual representation of a sequence of data transmission between a native environment and a JVM environment is presented. Example 400 represents one example of communication between native environment of native 402 and JVM environment of JVM 404, for example remote execution container 308 and Java process 306, respectively, of distributed Java virtual machine 304 all of FIG. 3. Native operations occur in native 402 and virtual machine operations are performed in JVM 404.

Operations 406 through 416 indicate an order in which operations occur within and between each environment. Native 402 initiates an action through operation 406 send(env, aArray) to JVM 404. JVM 404 receives the request and performs operation 408 Get Array elements to retrieve the requested array data. Native 402 receives data in operation 410 return(array elements) and processes the received data. When native 402 has finished with the array data, operation 412 send(env, aArray, elems, mode) is sent to JVM 404, which performs operation 414 Commit changes/free memory and subsequently returns a response message without a return value in operation 416 to complete the sequence of operations for the array process.

Many arrays are read-only, to the extent that the programming specification includes a mode setting in the Release<Type>ArrayElements call defining the mode as indicated in the following table:

| | |
|---|---|
| 0 | copy back and free buffer |
| JNI_COMMIT | copy back changes from buffer but do not |
| | free |
| JNI_ABORT | free the buffer without copying back (to be |
| | used when the application knows it has not |
| | modified the array) |

Regardless of whether the array is a read-only array, a second call to Release<Type>ArrayElements is always required to inform the JVM memory allocated for the array returned can be freed.

### SUMMARY

According to one embodiment, a computer-implemented process for remote array processing that receives a requested array in a remote execution container, generates a fingerprint of the requested array, bundles the fingerprint with the requested array and returns a pointer to array elements of the requested array to a caller. The computer-implemented process further receives a call to release the requested array from the caller to form a received release, determines, using the fingerprint, whether the requested array has been modified and responsive to a determination that the array has been modified, sending a call to release the requested array to a virtual machine and responsive to a determination that the array has not been modified, not sending a call to release the requested array to a virtual machine.

According to another embodiment, a computer program product for remote array processing comprises a computer recordable-type media having computer executable instructions stored thereon. The computer executable instructions comprise computer executable instructions for receiving a requested array in a remote execution container, computer executable instructions for generating a fingerprint of the requested array, computer executable instructions for bundling the fingerprint with the requested array, computer executable instructions for returning a pointer to array elements of the requested array to a caller, computer executable instructions receiving a call to release the requested array from the caller to form a received release, computer executable instructions for determining, using the fingerprint, whether the requested array has been modified, computer executable instructions responsive to a determination that the array has been modified, for sending a call to release the requested array to a virtual machine, computer executable instructions responsive to a determination that the array has not been modified, for not sending a call to release the requested array to a virtual machine.

According to another embodiment, an apparatus for remote array processing, comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a requested array in a remote execution container, generate a fingerprint of the requested array, bundle the fingerprint with the requested array and return a pointer to array elements of the requested array to a caller. The processor unit further executes the computer executable program code to direct the apparatus to receive a call to release the requested array from the caller to form a received release, determine, using the fingerprint, whether the requested array has been modified and responsive to a determination that the array has been modified, send a call to release the requested array to a virtual machine and responsive to a determination that the array has not been modified, not send a call to release the requested array to a virtual machine.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary network of data processing systems operable for various embodiments of the disclosure;

FIG. 2 is a block diagram of an exemplary data processing system operable for various embodiments of the disclosure;

FIG. 3 a pictorial representation of a split JVM environment;

FIG. 4 is a textual representation of a data transmission sequence between a native environment and a JVM environment;

FIG. 5 is a block diagram of an array manager in accordance with one embodiment of the disclosure;

FIG. 6 is a block diagram of a hybrid array data structure used with the array manager of FIG. 5, in accordance with various embodiments of the disclosure;

FIG. 7 is a textual representation of a data transmission sequence between a native environment and an enhanced JVM environment using a read-only array in accordance with various embodiments of the disclosure;

FIG. 8 is a textual representation of a data transmission sequence between a native environment and an enhanced JVM environment, in accordance with various embodiments of the disclosure;

FIG. 9 is a flowchart of a process using an array manager of FIG. 5, in accordance with one embodiment of the disclosure; and

FIG. 10 is a flowchart of another process using an array manager of FIG. 5, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Computer program code for carrying out operations of the present disclosure may be written in any combination of one or more programming languages, including an object oriented programming language such as Java™ programming language, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

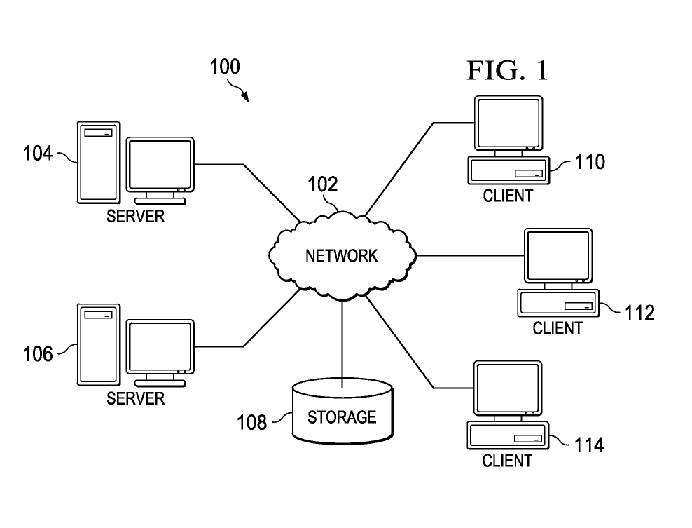

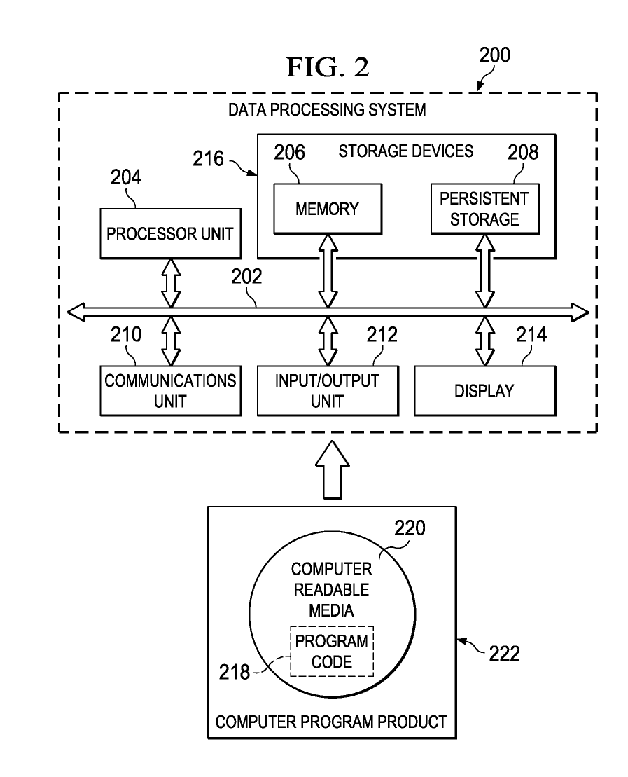

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Turning now to FIG. 2, a block diagram of an exemplary data processing system operable for various embodiments of the disclosure is presented. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications and/or programs may be located in storage devices 216, which are in communication with processor unit 204 through communications fabric 202. In these illustrative examples the instructions are in a functional form on persistent storage 208. These instructions may be loaded into memory 206 for execution by processor unit 204. The processes of the different embodiments may be performed by processor unit 204 using computer-implemented instructions, which may be located in a memory, such as memory 206.

These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 220 also may take the form of a persistent storage, such as a hard drive, a thumb drive, or a flash memory that is connected to data processing system 200. The tangible form of computer readable media 220 is also referred to as computer recordable storage media. In some instances, computer readable media 220 may not be removable.

Alternatively, program code 218 may be transferred to data processing system 200 from computer readable media 220 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

According to an illustrative embodiment using data processing system 200 of FIG. 2 as an example, processor unit 204 executes a computer-implemented process for remote array processing and receives a requested array in a remote execution container. In the example, processor unit 204 may be located on server 104 and remote execution container may be located on client 110 connected through network 102 all of FIG. 1. Processor unit 204 generates a fingerprint of the requested array, bundles the fingerprint with the requested array and returns a pointer to array elements of the requested array to a caller on client 110. The computer-implemented process further receives a call on client 110 to release the requested array from the caller to form a received release, determines, using the fingerprint, whether the requested array has been modified and responsive to a determination that the array has been modified. sends a call to release the requested array to a virtual machine on server 104 and responsive to a determination that the array has not been modified, not sending a call to release the requested array to a virtual machine on server 104.

In an alternative embodiment, program code 218 of FIG. 2 containing the computer-implemented process may be stored within computer readable media 220 as computer program product 222. In another illustrative embodiment, the process for remote array processing may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

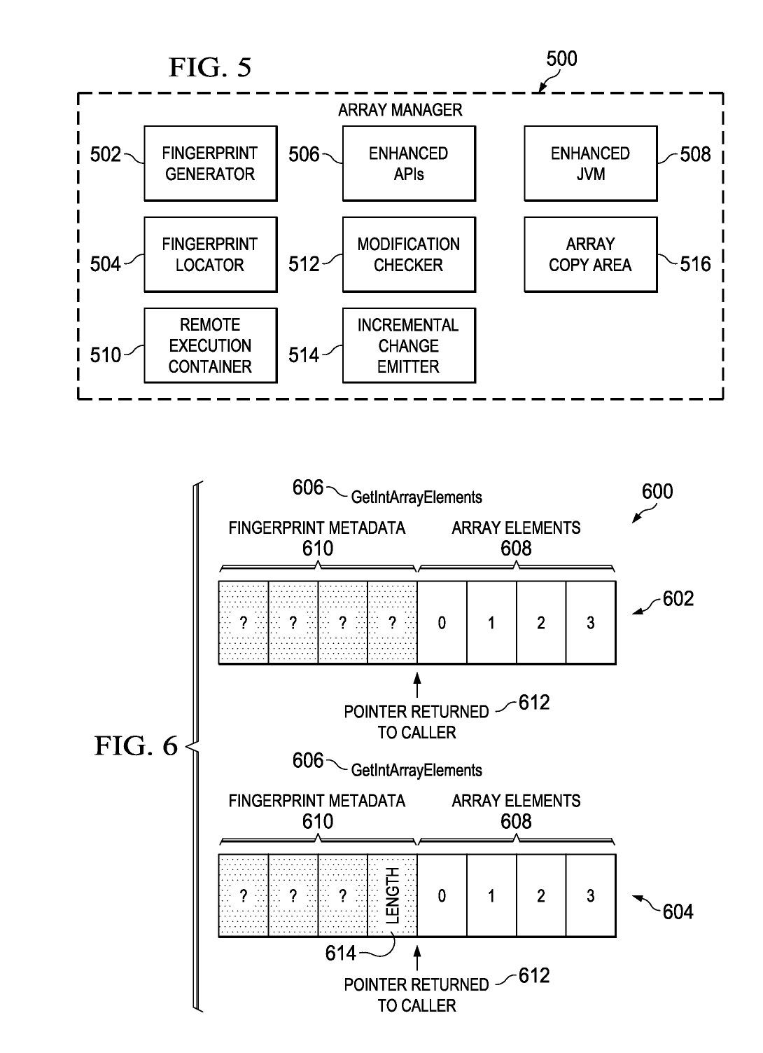

With reference to FIG. 5, a block diagram of an array manager in accordance with one embodiment of the disclosure is presented. Array manager 500 is one embodiment of the disclosure and is provided as an example without limitation.

Array manager 500 comprises a number of components including fingerprint generator 502, fingerprint locator 504, enhanced APIs 506, enhanced JVM 508, remote execution container 510, modification checker 512, incremental change emitter 514 and array copy area 516. Array manager 500 also relies on underlying system support from a data processing system such as data processing system 200 of FIG. 2 capable of supporting a Java virtual machine environment. Components of array manager 500 may be combined in other arrangements as necessary and do not necessarily have to be represented individually as shown while still providing the same capabilities. For example, components may be combined in various ways to create logical or physical blocks of function.

Fingerprint generator 502 provides a capability to create a unique fingerprint representing the content of a data array. A fingerprint generated may be affixed to an array providing a unique identifier representative of the array data content. Fingerprint locator 504 provides a capability to identify the position of a fingerprint when the fingerprint has been bundled with an array. Locating a fingerprint enables identification of the data component in a bundle of a fingerprint and associated array.

Enhanced APIs 506 provide access to modified capability of enhanced JVM 508 and remote execution container 510. Enhanced APIs 506 provide replacements for a selected set of previously used JVM functions for getting and releasing arrays. For example, Get<Type>ArrayElements/Release<Type>ArrayElements functions are enhanced in implementations of enhanced JVM 508 and remote execution container 510 and made accessible to developers using enhanced APIs 506.

Modification checker 512 provides a capability to analyze an array or a fingerprint associated with an array to determine whether a change has been made to the content of the array. Modification checker 512 can also identify a location of a change and content of a change as an incremental change. Incremental change emitter 514 provides a capability to transmit an identified incremental change made in array to a receiver. The capability enables array manager 500 to send only data related to a changed array rather than all of the data of a respective array.

Array copy area 516 provides a storage location in which an array may be saved. The saved array can then be compared with a current version of the array to determine whether the array was changed. The maximum size of an array that will be saved can be predefined as a configurable value to avoid allocating large amounts of storage space. For arrays that are larger than this value, a determination cannot be made as to whether an array has been modified using a fingerprint comparison method. In cases where a fingerprint comparison method cannot be used the array elements must be sent to the JVM unless a mode of JNI_ABORT has been specified in the call.

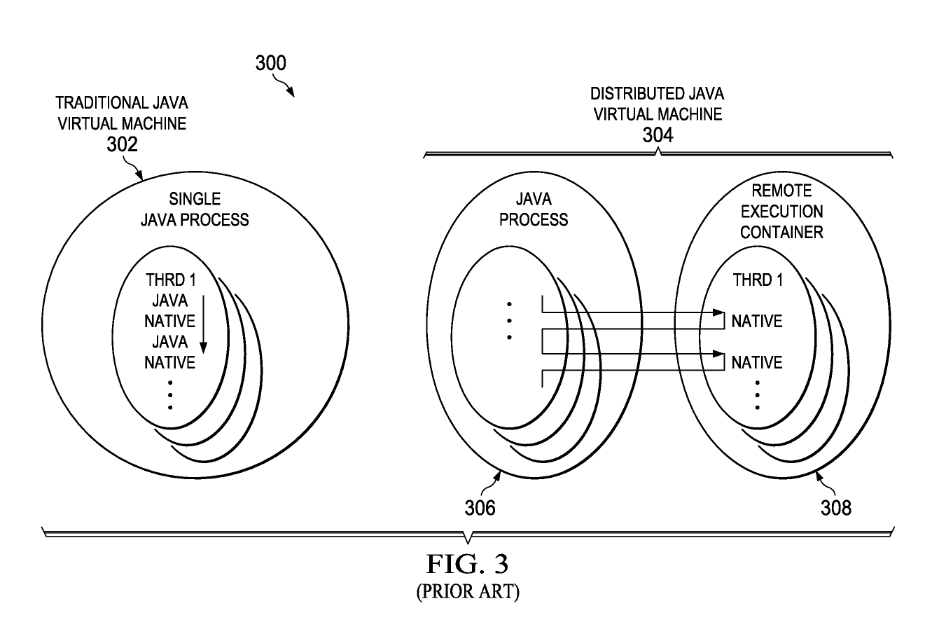

Array manager 500 provides a capability for reducing overhead imposed by a round trip required for functions of Get<Type>ArrayElements/Release<Type>ArrayElements. Typically when using arrays, content of many arrays is never modified; however the function Release<Type>ArrayElements must still be called by the application when using the array data. Using array manager 500 typically eliminates a second round-trip for the Release call for read-only arrays in a split JVM environment such as distributed Java virtual machine 304 of FIG. 3. Processes used in array manager 500 also apply to GetPrimitiveArrayCritical/ReleasePrimitiveArrayCritical, however, for clarity reference is made simply to Get<Type>ArrayElements/Release<Type>ArrayElements in the remainder of the disclosure.

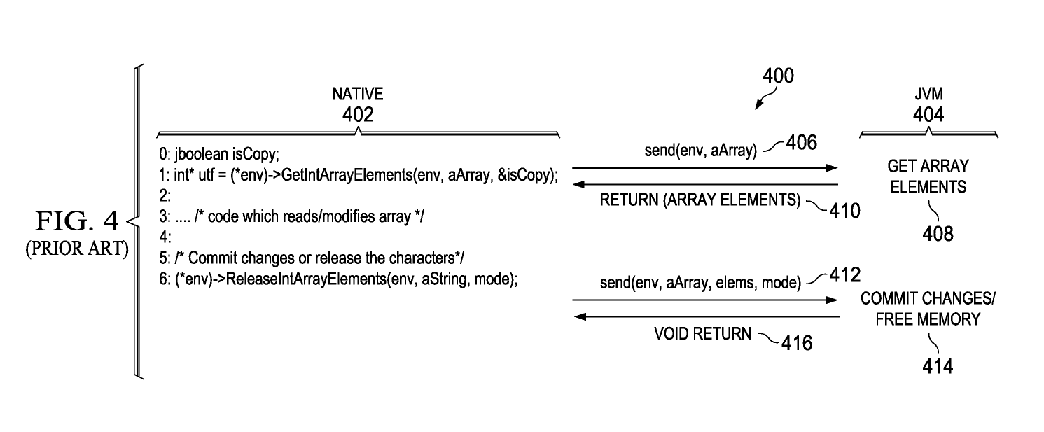

With reference to FIG. 6, a block diagram of hybrid array data structures used with the array manager of FIG. 4, in accordance with various embodiments of the disclosure is presented. Hybrid array data structures 600 depict examples of two data structures, structure 602 and structure 604, that may be used with array manager 400 of FIG. 4 to contain a requested array and an associated respective fingerprint.

In the example of structure 602 a request represented by Get function 606 may be used to obtain any of elements 0, 1, 2, and 3 of an array. Array elements 608 are returned to a caller and a fingerprint 610 of a fixed length is prefixed to array elements 608 to form a hybrid array data structure including pointer 612. Pointer 612 is provided to indicate a starting location of array data elements within the structure. Pointer 612 is passed to the caller for manipulating elements of the array data. Fingerprint 610, of a fixed length, may be generated by a suitable fingerprint generator and is representative of content of the array elements.

In the example of structure 604, a request represented by Get function 606 may be used to obtain any of elements 0, 1, 2, and 3 of an array as before. Array elements 608 are returned to a caller and a fingerprint 610 of a variable length is prefixed to array elements 608 to form a hybrid array data structure including pointer 612. In this example, fingerprint 610 includes a field 614 indicating a length of fingerprint 610. Example 604 has fingerprint 610 of a variable length, requiring the additional field 614 to provide length information for underlying services used to determine a location of pointer 612.

In another example, fingerprint 610 may be logically associated with array elements 608. A logical association in the form of a data descriptor may be used to provide fingerprint information representative of the array elements.

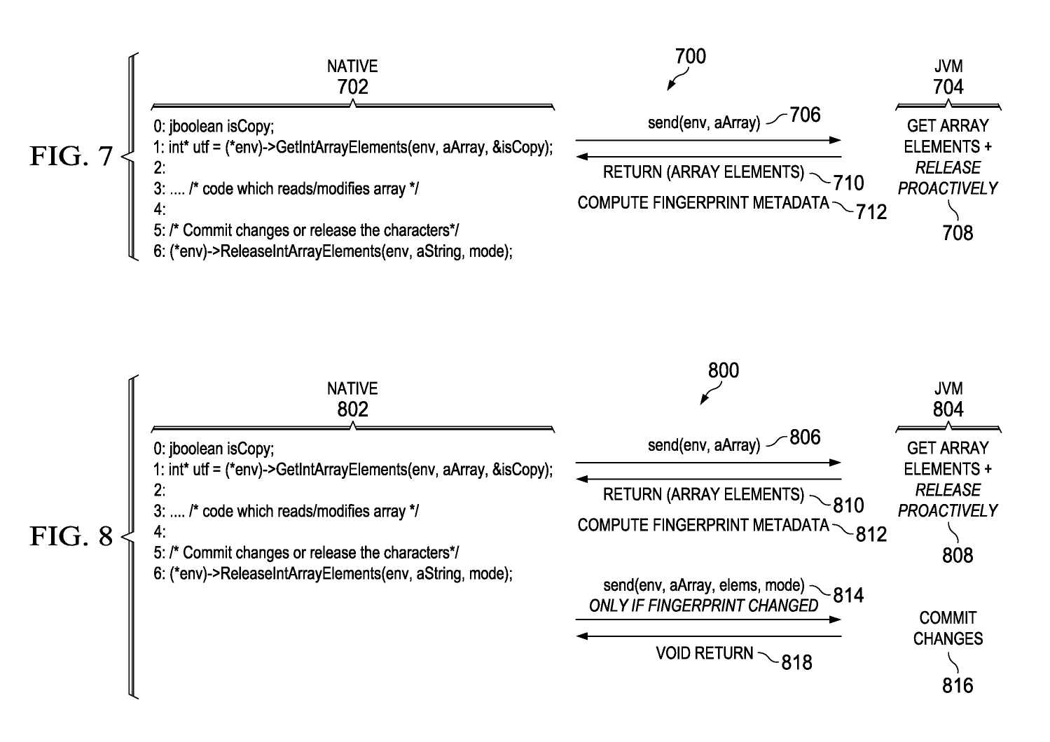

With reference to FIG. 7, a textual representation of a data transmission sequence between a native environment and a JVM environment using a read-only array in accordance with various embodiments of the disclosure is presented. Process 700 is an example of a data transmission sequence that occurs between a native, in a remote execution container and a JVM host during processing of a read-only array. In the example of process 700, native 702 communicates with JVM 704 to accomplish a task involving remote execution processing of an array.

In a split Java virtual machine such as native 702 communicating with JVM 704, when Get<Type>ArrayElements/Release<Type>ArrayElements are called there will be remote versions of the functions in native 702. These versions will then communicate with the remote JVM process where a service will invoke these functions on behalf of the remote execution container of native 702 and return the result. Process 700 consists of modifying the behavior in the remote execution container of native 702 and JVM 704 service comprising functions for get/release matching, fingerprinting and bundling, and unbundling and modification check.

A set of operations 706 through 712 is described. In operation 706, a request in the form of a call of send (env, aArray) is sent from native 702 to JVM 704 for processing. JVM 704 receives the request and initiates a command in operation 708 of Get array elements to locate and obtain requested array data from a storage location of the system. The data may be on the same system as JVM 704 or another system.

The array is located and released proactively. JVM 704 performs operation 710 return (array elements) to send the data to the caller of native 702. Native 702 performs operation 712 compute fingerprint metadata using the returned data to generate a fingerprint representative of the array data. A pointer to the array elements is returned to a caller enabling the caller to use the pointer to modify the elements as before, and a location of the metadata to be computed from the pointer efficiently.

A service on JVM 704 which calls Get<Type>ArrayElements is modified to immediately call Release<Type>ArrayElements after the service has created a copy that is forwarded to the caller in the remote execution container. The modification ensures all Get<Type>ArrayElements requests are matched with a corresponding Release<Type>ArrayElements function as required by the JNI specification. Without the enhanced or modified function, when a caller calls Release<Type>ArrayElements with a mode of JNI_ABORT a process would still need another remote call to perform the matching Release<Type>ArrayElements call.

JVM 704 performs operation 710 return (array elements) to send the data to the caller of native 702. When the array elements for an array are received in the remote execution container, a fingerprint of the characters of the data array is generated in operation 712 compute fingerprint metadata, such as fingerprint 610 of FIG. 6. The fingerprint metadata is bundled with the array elements. A pointer to the array elements is returned to a caller enabling the caller to use the pointer to modify the elements as before. In addition, a location of the fingerprint metadata can be computed from the pointer efficiently. One embodiment may affix a fingerprint of a fixed size, as shown in fingerprint 610 of example 602 of FIG. 6, enabling calculation of the address of the fingerprint directly from the address of the string characters.

In another example, when absolute certainty as to whether the array was modified is required (which is quite likely), a copy of the array may be maintained in a storage location such as array copy area 416 of array manager 400 of FIG. 4. A comparison of array data is guaranteed to detect any modification of array data. A configurable maximum array size may then be used to constrain storage allocation. When arrays larger than the size configured were modified, the modification cannot be determined using the comparison just described. In cases where the comparison cannot be used, the full array must be sent to the JVM on a release call unless a mode of JNI_ABORT has been specified.

With reference to FIG. 8, a textual representation of a data transmission sequence between a native environment and a JVM environment, in accordance with various embodiments of the disclosure is presented. Process 800 is an example of a data transmission sequence that occurs between a native, in a remote execution container and a JVM host during processing of an array. In the example of process 800, native 802 communicates with JVM 804 to accomplish a task involving remote execution processing of an array.

A set of operations 806 through 818 is described. In sequence number 806, a request in the form of a call of send (env, aArray) is sent from native 802 to JVM 804 for processing. JVM 804 receives the request and initiates a command in operation 808 of Get array elements to locate and obtain requested array data from a storage location of the system. The data may be on the same system as JVM 804 or another system. The array is located and released proactively because the read-only requirement implies no updating of the array content will occur.

JVM 804 performs operation 810 return (array elements) to send the data to the caller of native 802. Native 802 performs operation 812 compute fingerprint metadata using the returned data to generate the fingerprint. Having received the array elements, native 802 performs a series of operations as desired using the array elements. The operations performed by native 802 may also include reading and/or modifying array elements. Native 802 determines to commit changes of the array and performs operation 814 that issues command send (env, aArray, elems, mode) to JVM 804. The command is only required when native 802 changes the array content further indicated by a change in the fingerprint. In other cases when there is no change in the array content, there is no need to perform another pair of call/return communications and associated processing because the array elements were already released in operation 808.

Operation 816 commit change/free memory is executed on the JVM 804 in response to receiving the command of operation 814. Operation 818 receives a response message without a return value on native 802 to end the processing sequence for the array.

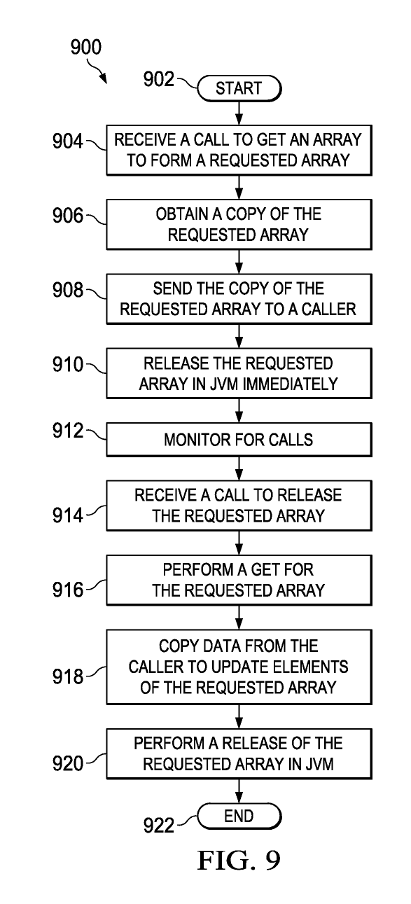

With reference to FIG. 9, a flowchart of a process using an array manager of FIG. 5, in accordance with one embodiment of the disclosure is presented. Process 900 is an example of a process using array manager 400 of FIG. 4 from a perspective of a host Java virtual machine.

Process 900 begins (step 902) and receives a call to Get an array to form requested array (step 904). Process 900 obtains a copy of the requested array (step 906). The copy may be obtained from a same system supporting process 900 or another system accessible to the system on which process 900 executes.

Process 900 sends the copy of the requested array to a caller (step 908). Process 900 releases the requested array immediately (step 910). An enhanced virtual machine performs the operation of releasing the array immediately to free the array for use by others and potentially avoid a subsequent call to release the array later.

Process 900 monitors for calls (step 912). Process 900 may sleep until another call arrives or perform other operations for other callers. Process 900 receives a call to release the requested array (step 914). When a determination is made that the array has been modified, process 900 receives a Release<Type>ArrayElements request. Process 900, in response to the received call, performs Get<Type>ArrayElements for the requested array (step 916). The Get<Type>ArrayElements call is for the same array that was obtained in step 906.

Process 900 copies data from the remote execution container of the requester to update elements of the requested array using the pointer returned by Get<Type>ArrayElements (step 918). Process 900 calls Release<Type>ArrayElements to perform a release of the requested array to free the array resources (step 920) and terminates thereafter (step 922). The process sequence is the same as before the optimization using the enhanced functions because the array was updated and therefore required a final get/release operation.

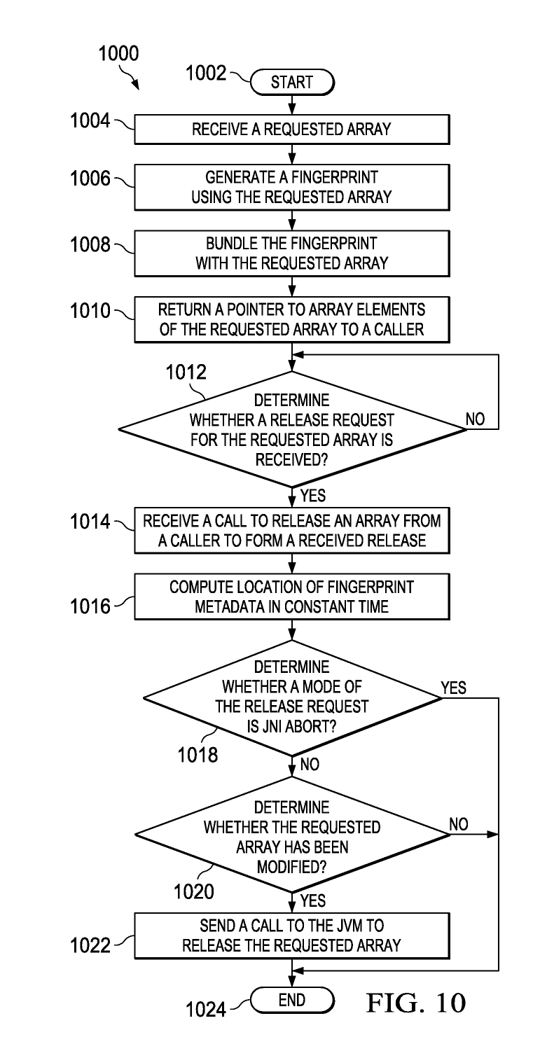

With reference to FIG. 10, a flowchart of a process using an array manager of FIG. 5, in accordance with one embodiment of the disclosure is presented. Process 1000 is an example from a remote execution container perspective of using array manager 500 of FIG. 5.

Process 1000 begins (step 1002) and receives a requested array (step 1004). Process 1000 generates a fingerprint using the requested array (step 1004). Data of the requested array is used in the generation of the fingerprint. Process 1000 bundles the fingerprint with the requested array (step 1008). The bundling may produce a physical bundle in which the fingerprint and the array data form a physical entity or a logical bundle in which the fingerprint is separate but associated logically with the array data.

Process 1000 returns a pointer to array elements of the requested array to a caller (step 1010). Process 1000 determines whether a release request for the requested array is received (step 1012). When a determination is made that a release request for the requested array is received, a “yes” result is obtained. When a determination is made that a release request for the requested array is not received, a “no” result is obtained.

When a “no” result is obtained instep 1012, process 1000 loops back to step 1012 to monitor for calls. When a “yes” result is obtained, process 1000 receives a call to release an array from the caller to form a received release (step 1014). The received release call of Release<Type>ArrayElements passes a pointer to the array elements characters for process 1000 use to compute a location of fingerprint metadata in constant time (step 1016). Process 1000 determines whether a mode of the release request is a JNI_ABORT mode (step 1018). When a determination is made that a mode of the release request is a JNI_ABORT mode, a “yes” result is obtained. When a determination is made that a mode of the release request is not a JNI_ABORT mode, a “no” result is obtained.

When a “yes” result is obtained, process 1000 terminates (step 1024). When a “no” result is obtained, process 1000 determines whether the requested array has been modified (step 1020). When a determination is made that the requested array has been modified, a “yes” result is obtained. When a determination is made that the requested array has not been modified, a “no” result is obtained.

When a “no” result is obtained in step 1020, process terminates (step 1024). Because the array has not been modified there is no need to send the request back to the JVM for processing. Because an initial call to Release<Type>ArrayElements was already performed by the JVM prior to sending the array data to the remote container caller, the array on the JVM was released immediately. The net result is that for all arrays not modified by the native or for which the mode of the release is JNI_ABORT a costly round trip using a Release<Type>ArrayElements call can be eliminated.

When a “yes” result is obtained in step 1020, process 1000 sends a call to release the requested array to the JVM (step 1022) and terminates thereafter (step 1024). The JVM performs a release process.

Thus is presented a computer-implemented process for remote array processing that receives a requested array in a remote execution container, generates a fingerprint of the requested array, bundles the fingerprint with the requested array and returns a pointer to array elements of the requested array to a caller. The computer-implemented process further receives a call to release the requested array from the caller to form a received release, determines, using the fingerprint, whether the requested array has been modified and responsive to a determination that the array has been modified, sending a call to release the requested array to a virtual machine and responsive to a determination that the array has not been modified, not sending a call to release the requested array to a virtual machine.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented process for remote array processing, the computer-implemented process comprising:
receiving a requested array in a remote execution container;
generating a fingerprint of the requested array;
bundling the fingerprint with the requested array;
returning a pointer to array elements of the requested array to a caller;
receiving a call to release the requested array from the caller to form a received release;
determining, using the fingerprint, whether the requested array has been modified;
responsive to a determination that the array has been modified, sending a call to release the requested array to a virtual machine; and
responsive to a determination that the array has not been modified, not sending a call to release the requested array to a virtual machine.

2. The computer-implemented process of claim 1, wherein receiving a requested array further comprises:
receiving a call from a remote execution container on the virtual machine to get an array to form a requested array;
obtaining a copy of the requested array;
sending the copy of the requested array from the virtual machine to the caller; and
releasing the requested array on the virtual machine, wherein the releasing is proactive.

3. The computer-implemented process of claim 1, wherein receiving a call to release the requested array to form a received release further comprises:
determining whether a release request for the requested array is received; and
responsive to determination that a release request for the requested array is not received, continuing to monitor for a release request.

4. The computer-implemented process of claim 1, wherein receiving a call to release the requested array to form a received release further comprises:
computing a location of fingerprint metadata in constant time.

5. The computer-implemented process of claim 1, wherein receiving a call to release the requested array to form a received release further comprises:
determining whether a mode of the release request is a Java native interface (JNI) abort mode; and
responsive to a determination that the mode of the release request is a JNI abort mode, aborting without calling a release request.

6. The computer-implemented process of claim 1, wherein sending a call to release the requested array to a virtual machine further comprises;
receiving a call to release the requested array on the virtual machine;
performing a get for the requested array;
copying data from the caller to update elements of the requested array on the virtual machine; and
performing a release of the requested array.

7. The computer-implemented process of claim 1, wherein determining, using the fingerprint, whether the requested array has been modified further comprises one of:
determining whether the fingerprint bundled with the requested array matches a computed fingerprint; and
determining whether a copy of the requested array maintained in an array copy area matches an array from the caller.

8. A computer program product for remote array processing, the computer program product comprising:
a computer recordable-type media having computer executable instructions stored thereon, the computer executable instructions comprising:
computer executable instructions for receiving a requested array in a remote execution container;
computer executable instructions for generating a fingerprint of the requested array;
computer executable instructions for bundling the fingerprint with the requested array;
computer executable instructions for returning a pointer to array elements of the requested array to a caller;
computer executable instructions receiving a call to release the requested array from the caller to form a received release;
computer executable instructions for determining, using the fingerprint, whether the requested array has been modified;
computer executable instructions responsive to a determination that the array has been modified, for sending a call to release the requested array to a virtual machine; and
computer executable instructions responsive to a determination that the array has not been modified, for not sending a call to release the requested array to a virtual machine.

9. The computer program product of claim 8, wherein computer executable instructions for receiving a requested array further comprises:
computer executable instructions receiving a call from a remote execution container on the virtual machine to get an array to form a requested array;
computer executable instructions for obtaining a copy of the requested array;
computer executable instructions for sending the copy of the requested array from the virtual machine to the caller; and
computer executable instructions for releasing the requested array on the virtual machine, wherein the releasing is proactive.

10. The computer program product of claim 8, wherein computer executable instructions for receiving a call to release the requested array to form a received release further comprises:
computer executable instructions for determining whether a release request for the requested array is received; and
computer executable instructions responsive to determination that a release request for the requested array is not received, for continuing to monitor for a release request.

11. The computer program product of claim 8, wherein computer executable instructions for receiving a call to release the requested array to form a received release further comprises:
computer executable instructions for computing a location of fingerprint metadata in constant time.

12. The computer program product of claim 8, wherein computer executable instructions for receiving a call to release the requested array to form a received release further comprises:
computer executable instructions for determining whether a mode of the release request is a Java native interface (JNI) abort mode; and
computer executable instructions responsive to a determination that the mode of the release request is a JNI abort mode, for aborting without calling a release request.

13. The computer program product of claim 8, wherein computer executable instructions for sending a call to release the requested array to a virtual machine further comprises:
computer executable instructions for receiving a call to release the requested array on the virtual machine;
computer executable instructions for performing a get for the requested array;
computer executable instructions for copying data from the caller to update elements of the requested array on the virtual machine; and
computer executable instructions for performing a release of the requested array.

14. The computer program product of claim 8, wherein computer executable instructions for determining, using the fingerprint, whether the requested array has been modified further comprises one of:
computer executable instructions for determining whether the fingerprint bundled with the requested array matches a computed fingerprint; and
computer executable instructions for determining whether a copy of the requested array in an array copy area matches an array from the caller.

15. An apparatus for remote array processing, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receiving a requested array in a remote execution container;
generate a fingerprint of the requested array;
bundle the fingerprint with the requested array;
return a pointer to array elements of the requested array to a caller;
receive a call to release the requested array from the caller to form a received release;
determine, using the fingerprint, whether the requested array has been modified;
responsive to a determination that the array has been modified, send a call to release the requested array to a virtual machine; and
responsive to a determination that the array has not been modified, not send a call to release the requested array to a virtual machine.

16. The apparatus of claim 15, wherein the processor unit executes the computer executable program code to receive a requested array further directs the apparatus to:
receive a call from a remote execution container on the virtual machine to get an array to form a requested array;
obtain a copy of the requested array;
send the copy of the requested array from the virtual machine to the caller; and
release the requested array on the virtual machine, wherein the release is proactive.

17. The apparatus of claim 15, wherein the processor unit executes the computer executable program code to receive a call to release the requested array to form a received release further directs the apparatus to:
compute a location of fingerprint metadata in constant time.

18. The apparatus of claim 15, wherein the processor unit executes the computer executable program code to receive a call to release the requested array to form a received release further directs the apparatus to:
determine whether a mode of the release request is a JNI abort mode; and
responsive to a determination that the mode of the release request is a JNI abort mode, abort without calling a release request.

19. The apparatus of claim 15, wherein the processor unit executes the computer executable program code to send a call to release the requested array to a virtual machine further directs the apparatus to:
receive a call to release the requested array on the virtual machine;
perform a get for the requested array;
copy data from the caller to update elements of the requested array on the virtual machine; and
perform a release of the requested array.

20. The apparatus of claim 15, wherein the processor unit executes the computer executable program code to determine, using the fingerprint, whether the requested array has been modified further directs the apparatus to perform one of:
determine whether the fingerprint bundled with the requested array matches a computed fingerprint; and
determine whether a copy of the requested array maintained in an array copy area matches an array from the caller.
